(19) United States
(12) Patent Application Publication
(10) Pub. No.: US 2015/0166032 A1
(43) Pub. Date: Jun. 18, 2015

(54) ELECTRONIC PARKING BRAKE SYSTEM AND CONTROL METHOD THEREOF

(71) Applicant: MANDO CORPORATION, Pyeongtaek-si (KR)

(72) Inventor: Su-Hwan NO, Seongnam-si (KR)

(21) Appl. No.: 14/308,403

(22) Filed: Jun. 18, 2014

(30) Foreign Application Priority Data
Dec. 12, 2013 (KR) 10-2013-0154536

(51) Int. Cl. B60T 13/74; B60T 11/04

(52) U.S. Cl. CPC B60T 13/746; B60T 11/046; F16D 2121/24

(57) ABSTRACT

Disclosed are an electronic parking brake system and a control method thereof. The electronic parking brake system includes a brake, a parking cable to apply braking force to the brake, a motor configured to rotate in a regular direction or a reverse direction to apply tension to the parking cable, a motor driving unit to drive the motor, a current sensor to sense current of the motor, a hall sensor to sense a rotating position of the motor, and a control unit to control the motor driving unit. When the brake is released, the control unit determines whether a rotating position value of the motor sensed through the hall sensor reaches a preset value, and stops the motor through the motor driving unit after a preset time has elapsed since the sensed rotating position value of the motor has reached the preset value.

### CROSS-REFERENCE TO RELATED APPLICATION

This application claims the benefit of Korean Patent Application No. 2013-0154536, filed on Dec. 12, 2013 in the Korean Intellectual Property Office, the disclosure of which is incorporated herein by reference.

### BACKGROUND

1. Field

Embodiments of the present invention relate to an electronic parking brake system and a control method thereof, and more particularly to, an electronic parking brake system and a control method thereof which controls operation or release of an electronic parking brake.

2. Description of the Related Art

In general, a brake system is a system which decelerates and stops a vehicle during driving and simultaneously maintains the stopped state of the vehicle. The brake system includes a parking brake apparatus which decelerates and stops a vehicle during driving and simultaneously maintains the stopped state of the vehicle.

The parking brake apparatus is configured such that, when a lever provided at one side of a driver's seat in a vehicle is manipulated, a parking cable is pulled and then provides braking force to vehicle wheels connected to the parking cable to maintain a stopped state of the vehicle wheels, and, when the lever is released, the parking cable is loosened to release the braking force from the vehicle wheels. Such an operating type of the parking brake apparatus to supply braking force to the vehicle wheels or release the braking force from the vehicle wheels using tension of the parking cable is referred to as a cable puller type.

Regarding such a cable puller type parking brake apparatus, a driver should manipulate the lever whenever the parking brake apparatus is operated, i.e. parking or driving of the vehicle is started, only by driver's intention, and thus use of the parking brake apparatus is very inconvenient. Therefore, an electronic parking brake (EPB) system which enables a parking brake apparatus to be automatically operated by a motor according to an operating state of a vehicle has been developed.

The electronic parking brake (EPB) system operates the parking brake apparatus or stops the operation of the parking brake apparatus and ensures stability in braking in case of emergency in connection with a manual operation mode, a hydraulic electronic control unit (HECU), an engine electronic control unit (ECU), and a traction control unit (TCU) through switch manipulation.

Such an electronic parking brake (EPB) system includes an electronic control unit (ECU), a motor, a gear, a parking cable, and a force sensor, which are integrally formed. Here, the electronic control unit (ECU) receives related data input from the hydraulic electronic control unit (HECU), the engine electronic control unit (ECU), and the traction control unit (TCU), through controller area network (CAN) communication, understands driver's intention, and then drives the motor. Then, the gear is operated by driving of the motor, and the parking cable is pulled by the operation of the gear to provide braking force to vehicle wheels, thereby maintaining a stable state of the vehicle. Here, tension of the parking cable is sensed by the force sensor, and the operation of the brake or release of the brake is performed according to tension of the parking cable sensed by the force sensor.

However, the force sensor to sense tension of the parking cable has a large size and a complicated structure and is expensive, and thus the size of the electronic parking brake (EPB) system is also increased and manufacturing costs thereof rise. In addition, since an assembling efficiency of the electronic parking brake (EPB) system is deteriorated, effective countermeasures against the above problems have been demanded.

### SUMMARY

It is an aspect of the present invention to provide an electronic parking brake system and a control method thereof capable of controlling operation or release of an electronic parking brake using current of a motor and a position of a motor without using a force sensor.

Additional aspects of the invention will be set forth in part in the description which follows and, in part, will be obvious from the description, or may be learned by practice of the invention.

In accordance with one aspect of the present invention, an electronic parking brake system comprises: a brake; a parking cable to apply braking force to the brake; a motor configured to rotate in a regular direction or a reverse direction to apply tension to the parking cable; a motor driving unit to drive the motor; a current sensor to sense current of the motor; a hall sensor to sense a rotating position of the motor; and a control unit to control the motor driving unit. When the brake is released, the control unit determines whether a rotating position value of the motor sensed through the hall sensor reaches a preset value, and stops the motor through the motor driving unit after a preset time has elapsed since the sensed rotating position value of the motor has reached the preset value.

The preset value may be a rotating position value of the motor when tension of the parking cable is approximately zero.

The electronic parking brake system may further include a storage unit to store the preset value, and the preset value may be a rotating position value of the motor sensed when a current value of the motor sensed through the current sensor in the operation of the brake reaches a current value corresponding to tension value zero when tension of the parking cable is approximately zero, and the control unit may store the preset value in the storage unit.

In accordance with another aspect of the present invention, an electronic parking brake system comprises: a brake; a parking cable to apply braking force to the brake; a motor configured to rotate in a regular direction or a reverse direction to apply tension to the parking cable; a motor driving unit to drive the motor; a current sensor to sense current of the motor; a hall sensor to sense a rotating position of the motor; a storage unit to store a rotating position of the motor; and a control unit to control the motor driving unit. The control unit stores a rotating position value of the motor sensed when a current value of the motor sensed through the current sensor reaches a preset value in the storage unit when the brake is operated, senses a rotating position of the motor when the brake is released, and stops the motor through the motor driving unit after a preset time has elapsed since the sensed rotating position value of the motor has reached the rotating position value of the motor stored in the storage unit.

When the brake is operated, and if a current value of the motor sensed through the current sensor reaches a current value corresponding to tension value zero when tension of the parking cable is approximately zero, the control unit may sense a rotating position of the motor through the hall sensor and may store the sensed rotating position value of the motor in the storage unit.

When the brake is operated, and if a rotating position value of the motor sensed through the hall sensor reaches a preset value, the control unit may stop the motor.

In accordance with a further aspect of the present invention, an electronic parking brake system comprises: a brake; a parking cable to apply braking force to the brake; a motor configured to rotate in a regular direction or a reverse direction to apply tension to the parking cable; a motor driving unit to drive the motor; a current sensor to sense current of the motor; a hall sensor to sense a rotating position of the motor; and a control unit to control the motor driving unit. When the brake is released, the control unit estimates a point of time of stopping the motor based on a rotating position of the motor when a current value of the motor generated in the operation of the brake reaches a current value corresponding to tension value zero when tension of the parking cable is approximately zero, and stops the motor through the motor driving unit at the estimated point of time of stopping the motor.

The point of time of stopping the motor estimated by the control unit may be a point of time when a preset time has elapsed since a rotating position value of the motor sensed through the hall sensor in the release of the brake has reached a rotating position value of the motor when a current value of the motor generated in the operation of the brake reaches a current value corresponding to tension value zero when tension of the parking cable is approximately zero.

In accordance with a further aspect of the present invention, a control method of an electronic parking brake system comprises: sensing current of a motor applying tension to a parking cable when a brake is operated; sensing a rotating position value of the motor when the sensed current of the motor reaches a preset value; storing the sensed rotating position of the motor; sensing a rotating position of the motor when the brake is released; determining whether the sensed rotating position value of the motor reaches the stored rotating position value of the motor; and stopping the motor according to a determination result.

The stopping the motor may include stopping the motor after a preset time has elapsed since the sensed rotating position value of the motor has reached the stored rotating position value of the motor.

The sensing the rotating position of the motor when the brake is operated may include sensing a rotating position of the motor when the sensed current of the motor reaches a current value corresponding to tension value zero when tension of the parking cable is approximately zero.

As is apparent from the above description, since the electronic parking brake system according to the present invention controls the operation or release of the electronic parking brake using the current of the motor and the rotating position of the motor, manufacturing costs and assembling processes associated with installation of a conventional force sensor to sense tension of the parking cable may be reduced.

Further, when the brakes are operated, the rotating position value of the motor when the tension of the parking cable is approximately zero is estimated. Accordingly, when the brakes are released, the motor may be stopped depending on whether the rotating position value of the motor reaches the rotating position value of the motor when the tension of the parking cable is approximately zero. As a result, unnecessary operational load for release of the brakes may be eliminated.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a constitutional view schematically illustrating an electronic parking brake system according to an exemplary embodiment of the present invention;

FIG. 2 is a control block diagram of the electronic parking brake system according to an exemplary embodiment of the present invention;

FIG. 3 is a view to explain a relationship among current of a motor, tension value zero (tension of a parking cable is zero), and a rotating position of a motor when the brake is operated and released in the electronic parking brake system according to an exemplary embodiment of the present invention; and

FIGS. 4 and 5 are flow charts of a control method of the electronic parking brake system according to an exemplary embodiment of the present invention.

### DETAILED DESCRIPTION

Reference will now be made in detail to the preferred embodiments of the present invention, examples of which are illustrated in the accompanying drawings. The preferred embodiments described in the specification and shown in the drawings are illustrative only and are not intended to represent all aspects of the invention, such that various equivalents and modifications can be made without departing from the spirit of the invention. In the following description of the present invention, a detailed description of known functions and configurations incorporated herein will be omitted when it may make the subject matter of the present invention rather unclear. In the drawings, the widths, the lengths, the thicknesses, etc. of elements may be exaggerated for convenience of description. Further, in the drawings, the same or similar elements are denoted by the same reference numerals even though they are depicted in different drawings.

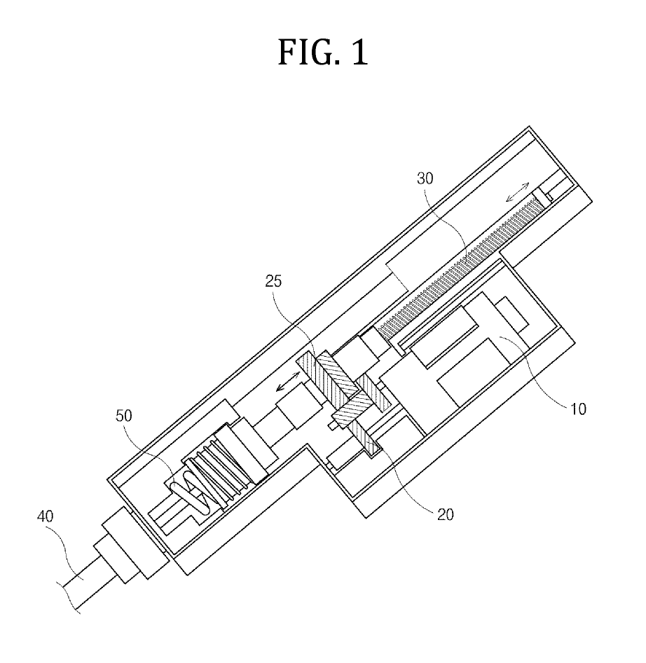

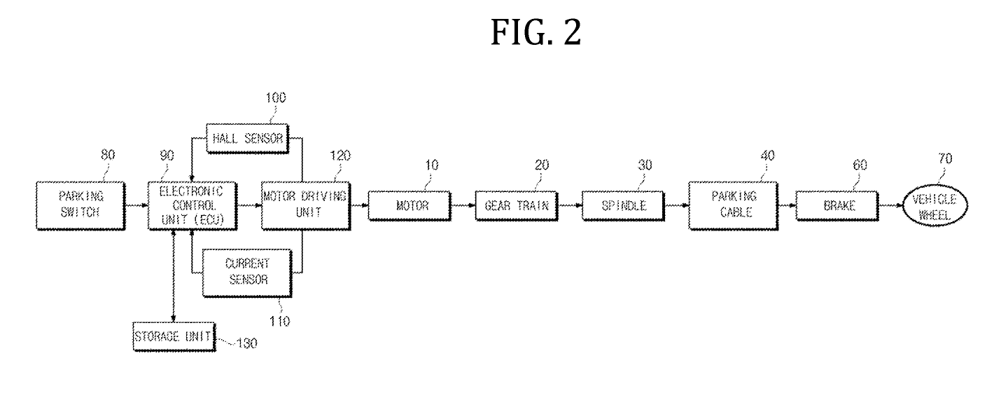

FIG. 1 is a constitutional view schematically illustrating an electronic parking brake system according to an exemplary embodiment of the present invention, and FIG. 2 is a control block diagram of the electronic parking brake system according to an exemplary embodiment of the present invention.

Referring to FIG. 1, an electronic parking brake apparatus is a cable puller type electronic parking brake apparatus, and includes a motor 10, a gear train 20, a nut member 25, a spindle 30, a parking cable 40, and an elastic member 50. An electronic parking brake system includes the electronic parking brake apparatus, brakes 60, vehicle wheels 70, a parking switch 80, an electronic control unit (ECU) 90, a hall sensor 100, a current sensor 110, and a motor driving unit 120.

The motor 10 is rotated in a regular direction or the reverse direction through power supplied from a battery, and supplies braking force to the brakes 60 or releases the braking force from the brakes 60, thereby operating the brakes 60 or stopping the operation of the brakes 60.

The gear train 20 is driven by rotation of the motor 10 and includes a plurality of gears engaged with each other by helical gear teeth formed on the outer circumferential surfaces thereof and rotated, thereby rectilinearly reciprocating the spindle 30. The gear train 20 is provided with the nut member 25, which is screw-coupled to the spindle 30 and moves in the opposite direction to the moving direction of the spindle 30.

The spindle 30 is formed with a screw on the outer circumferential surface thereof, and the screw is screw-coupled to the nut member 25 of the gear train 20. Thereby, as the gear train 20 is driven, the spindle 30 is rotated in the nut member 25 and moves rectilinearly. The parking cable 40 is connected to a tip of the spindle 30, and thus the parking cable 40 is pulled or loosened according to rectilinear movement of the spindle 30. When the spindle 30 moves, repulsive force corresponding to moving force of the spindle 30 is applied to the nut member 25 of the gear train 20.

The parking cable 40 is connected to the tip of the spindle 30, and is pulled or loosened according to movement of the spindle 30, thereby providing braking force to the brakes 60.

The elastic member 50 is compressed corresponding to movement of the nut member 25 of the gear train 20. That is, the elastic member 50 is compressed based on tension applied to the parking cable 40 according to movement of the spindle 30 corresponding to movement of the nut member 25.

The brakes 60 are respectively installed at left and right rear vehicle wheels, and are connected to the spindle 30 through the parking cable 40. When tension of the parking cable 40 corresponding to rectilinear movement of the spindle 30 is transmitted to the brakes 60, the brakes 60 supply braking force to the vehicle wheels 70 or release the braking force from the vehicle wheels 70.

The parking switch 80 transmits a parking mode set signal to the electronic control unit 90 when the parking switch 80 is turned on by a user. That is, the parking switch 80 is configured such that, when the parking switch 80 is turned on, conversion between the parking mode and the parking release mode of the vehicle is automatically achieved according to a change in the state of the vehicle.

The electronic control unit 90 is configured to perform overall control of the electronic parking brake system.

The hall sensor 100 outputs a pulse according to rotation of a rotor of the motor 10 in a regular direction or the reverse direction to the electronic control unit 90. The electronic control unit 90 counts the pulse and detects a rotating position of the motor corresponding to the counted pulse value. That is, the electronic control unit 90 detects a rotating position of the motor 10 based on the counted value of the pulse output from the hall sensor 100 in consideration of rotation of the motor 10 in the regular direction or the reverse direction. For example, the electronic control unit 90 detects a current rotating position of the motor 10 based on the counted pulse in such a manner that the pulse output from the hall sensor 100 when the motor 10 is rotated in the regular direction is assigned a positive value and the pulse output from the hall sensor 100 when the motor 10 is rotated in the reverse direction is assigned a negative value.

The current sensor 110 senses current flowing in the motor 10 when the motor 10 is rotated in the regular direction or the reverse direction, and outputs the current to the electronic control unit 90.

Here, force repulsive to moving force of the spindle 30 pulling the parking cable 40 when the motor 10 is rotated is applied to the nut member 25 and thus the nut member 25 is moved, and the elastic member 50 is compressed by moving force of the nut member 25. That is, the nut member 25 is moved by rotation of the motor 10 while compressing the elastic member 50, and the moving force of the nut member 25 corresponds to rotating force of the motor 10. Accordingly, tension of the parking cable 40 may be calculated based on current of the motor 10 corresponding to the rotating force of the motor 10.

According to experiments, dispersion of current of the motor with respect to tension of the parking cable by voltage and temperature when the brakes 60 are operated is, e.g., about 4 A at most, which is similar to the value of dispersion in the electronic parking brake system.

Also, current waveform distortion according to pulse width modulation (PWM, Duty & RPM) control does not occur when the brakes 60 are operated, and dispersion of current of the motor is, e.g., about 3 A at most, which is similar to the value of dispersion in the electronic parking brake system.

As described above, it may be understood that there is a direct correlation between current of the motor and tension of the parking cable. Based on the experimental results, current of the motor when tension of the parking cable is zero in operation of the brakes 60 may be known. Thereby, a rotating position of the motor when tension of the parking cable is zero may be estimated using the current sensor without a force sensor. Further, a rotating position of the motor when tension of the parking cable is zero may be more accurately estimated than when the force sensor is used.

Referring to FIG. 2, the motor driving unit 120 acts to rotate the motor 10 in the regular direction or the reverse direction according to a control signal of the electronic control unit 90.

The storage unit 130 stores a rotating position value of the motor at the time in which a current value of the motor sensed through the current sensor 110 reaches a current value corresponding to tension value zero of the parking cable 40 when the brakes are operated according to a control signal of the electronic control unit 90. The rotating position value of the motor may be preset based on the experimental results, and may be stored in advance in the storage unit 130.

When a parking mode set signal is input from the parking switch 80 to the electronic control unit 90, the electronic control unit 90 sets a parking mode, and determines whether or not the mode change from the parking mode into the parking release mode or from the parking release mode into the parking mode is carried out by analyzing a state of the vehicle based on data transmitted from various sensors or various systems. If it is determined that the mode change is carried out, the electronic control unit 90 controls operation of the brakes. Further, the electronic control unit 90 controls rotation of the motor 10 through the motor driving unit 120 according to the parking mode or the parking release mode to rotate the motor 10 in the regular direction or the reverse direction, thereby operating the brakes 60 or stopping the operation of the brakes 60.

The electronic control unit 90 estimates tension of the parking cable 40 based on current flowing in the motor 10 when the parking mode or the parking release mode is performed, predicts braking force of the brakes 60 based on the estimated tension of the parking cable 40, and controls rotation of the motor 10 based on the predicted braking force, thereby controlling the tension of the parking cable 40 and the braking force of the brakes 60.

The electronic control unit 90 estimates the rotating position value of the motor when the tension of the parking cable 40 is approximately zero using the current value of the motor sensed through the current sensor 110 when the brakes 60 are applied, and stops the motor 10 depending on whether the rotating position value of the motor sensed through the hall sensor 100 reaches the estimated rotating position value of the motor when the brakes 60 are released.

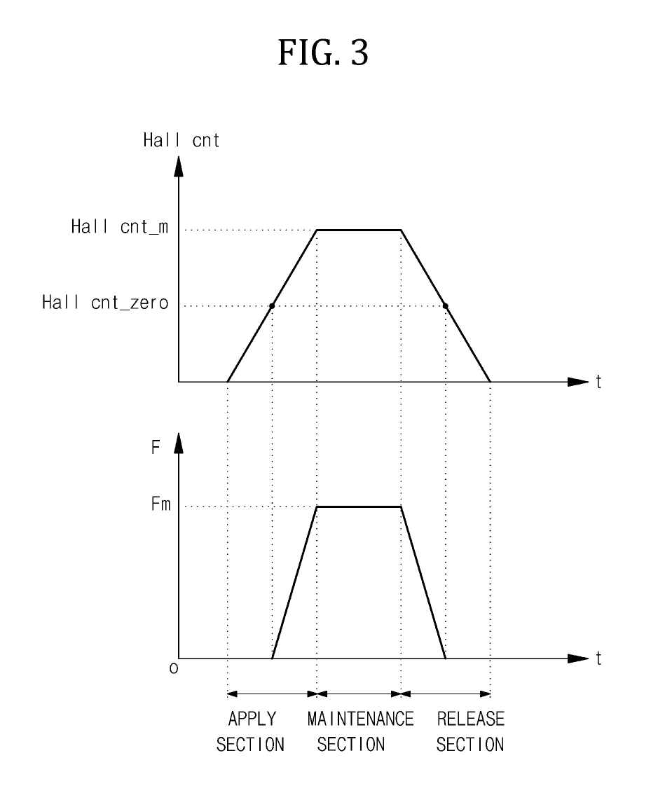

Describing in detail with reference to FIG. 3, the electronic control unit 90 rotates the motor 10 in one direction (e.g., in the regular direction) through the motor driving unit 120 so as to provide braking force to the brakes 60 when the brakes 60 are applied.

Also, the electronic control unit 90 senses the current of the motor through the current sensor 110. If the current value sensed through the current sensor 110 reaches a first current value preset corresponding to tension value zero (i.e., tension of the parking cable 40 is approximately zero), the electronic control unit 90 stores the rotating position value of the motor sensed through the hall sensor 100 in the storage unit 130.

If the current of the motor sensed through the current sensor 110 reaches a second current value (second current value>first current value) preset corresponding to a preset tension of the parking cable 40 (e.g., the maximum tension value of the parking cable), the electronic control unit 90 stops the motor 10. Even when the motor 10 is stopped by self-locking mechanism, typically using screws, the braking force supplied to the brakes 60 is maintained.

Meanwhile, the electronic control unit 90 rotates the motor 10 in the opposite direction (e.g., in the reverse direction) through the motor driving unit 120 so as to release braking force from the brakes 60 in stopping the operation of the brakes 60.

At this time, the electronic control unit 90 senses the rotating position value of the motor 10 through the hall sensor 100. If the rotating position value of the motor sensed through the hall sensor 100 reaches the rotating position value of the motor stored in the storage unit 130, the electronic control unit 90 stops the motor 10 through the motor driving unit 120 after a preset time has elapsed since the rotating position value of the motor sensed through the hall sensor 100 has reached the rotating position value of the motor stored in the storage unit 130.

Hereinafter, for convenience of explanation, the explanation will be made under the condition such that if the motor 10 is rotated in the regular direction, the braking force is applied to the brakes 60, and if the motor 10 is rotated in the reverse direction, the braking force is released from the brakes 60.

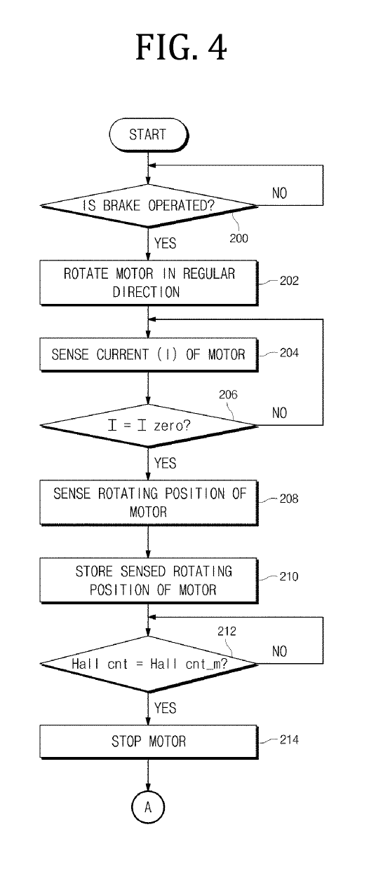

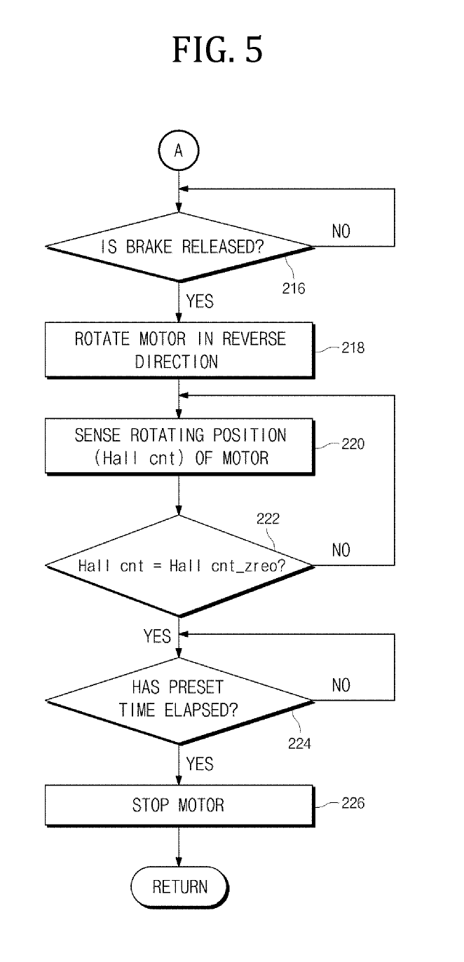

FIGS. 4 and 5 are flow charts of a control method of the electronic parking brake system according to an exemplary embodiment of the present invention.

Referring to FIGS. 4 and 5, the electronic control unit 90 determines whether the brakes 60 need to be operated, e.g., by turning the parking switch 80 on at operation 200. If it is determined that the brakes 60 need to be operated, the electronic control unit 90 rotates the motor 10 in the regular direction through the motor driving unit 120 at operation 202. As the motor 10 is rotated in the regular direction, rotating force of the motor 10 is converted into rectilinear movement of the spindle 30 by the gear train 20, and the parking cable 40 fixed to the tip of the spindle 30 is pulled by the movement of the spindle 30. Thereby, the brakes 60 provided at the vehicle wheels 70 are operated.

While rotating the motor 10 in the regular direction, the electronic control unit 90 senses current of the motor through the current sensor 110.

After sensing the current of the motor, the electronic control unit 90 compares the sensed current I of the motor with the preset first current I_zero (for example, current value corresponding to tension value zero, i.e., when tension of the parking cable 40 is approximately zero), and determines whether the sensed current I of the motor reaches the preset first current I_zero at operation 206.

If it is determined at operation 206 that the sensed current I of the motor reaches the preset first current I_zero, the electronic control unit 90 senses a rotating position Hall cnt_zero of the motor at that time through the hall sensor 100 at operation 208. The electronic control unit 90 stores the sensed rotating position Hall cnt_zero of the motor in the storage unit 130. At this time, the rotating position Hall cnt_zero of the motor sensed through the hall sensor 100 has a value corresponding to tension value zero (i.e., tension of the parking cable 40 is approximately zero). If it is determined at operation 206 that the sensed current I of the motor does not reach the preset first current I_zero, the process returns to operation 204 and repeats the above-described operations.

As the motor 10 is rotated in the regular direction, the electronic control unit 90 determines whether a rotating position value Hall cnt of the motor 10 reaches a preset value Hall cnt_m at operation 212.

If it is determined at operation 212 that the rotating position value Hall cnt of the motor 10 does not reach the preset value Hall cnt_m, the process repeats operation 212.

If it is determined at operation 212 that the rotating position value Hall cnt of the motor 10 reaches the preset value Hall cnt_m, the electronic control unit 90 stops the motor 10 through the motor driving unit 120 at operation 214. At this time, even when the motor 10 is stopped by self-locking mechanism, typically using screws, the braking force supplied to the brakes 60 is maintained.

Meanwhile, the electronic control unit 90 determines whether the brakes 60 need to be released at operation 216. If it is determined that the brakes 60 need to be released, the electronic control unit 90 rotates the motor 10 in the reverse direction through the motor driving unit 120 at operation 218.

While rotating the motor 10 in the reverse direction, the electronic control unit 90 senses a rotating position of the motor through the hall sensor 100 at operation 220.

After sensing the rotating position of the motor, the electronic control unit 90 determines whether the rotating position Hall cnt of the motor 10 reaches the rotating position Hall cnt_zero of the motor stored in the storage unit 130 as the motor 10 is rotated in the reverse direction at operation 222.

If it is determined at operation 222 that the rotating position Hall cnt of the motor 10 does not reach the rotating position Hall cnt_zero of the motor stored in the storage unit 130, the process returns to operation 220 and repeats the above-described operations.

If it is determined at operation 222 that the rotating position Hall cnt of the motor 10 reaches the rotating position Hall cnt_zero of the motor stored in the storage unit 130, the electronic control unit 90 determines whether the preset time has elapsed since the rotating position Hall cnt of the motor 10 has reached the rotating position Hall cnt_zero of the motor stored in the storage unit 130 at operation 224.

If it is determined that the preset time has not elapsed, the process repeats operation 224.

If it is determined that the preset time has elapsed, the electronic control unit 90 stops the motor 10 through the motor driving unit 120 at operation 226.

In summary, it may be known from experiments that there is a direct correlation between current of the motor and tension of the parking cable. By using such a correlation, current of the motor corresponding to tension value zero (i.e., tension of the parking cable is approximately zero) may be detected when the brakes 60 are operated. Thereby, a rotating position of the motor when the tension of the parking cable is approximately zero may be estimated using the current sensor without a force sensor. Further, the rotating position of the motor when the tension of the parking cable is approximately zero may be estimated more accurately than when using a force sensor. Since the rotating position value of the motor when the tension of the parking cable is approximately zero is obtained, when the brakes 60 are released, and if the rotating position value of the motor reaches the rotating position value of the motor corresponding to tension value zero of the parking cable, the motor 10 is stopped. At this time, even though the motor 10 is stopped after a given time has elapsed by a preset margin, unnecessary operational load for release of the brakes may be considerably reduced, compared with when a conventional force sensor is used to stop the motor 10.

A method of stopping the motor using a conventional force sensor includes stopping the motor 10 after a preset time has elapsed since an output value of a force sensor has reached a certain value which is preset to stop the motor. However, because the force sensor has limitation in response and resolution and an output signal from the force sensor has noises, it is difficult to detect accurately a point of time when tension of the parking cable becomes zero. Therefore, although the output value from the force sensor reaches a preset value, the motor should be stopped after a relatively long time interval, thereby increasing operational load for release of the brakes.

According to the present invention, by using current of the motor having a direct correlation with tension of the parking cable instead of using a force sensor, a rotating position value of the motor when tension of the parking cable is approximately zero is obtained when the brakes are applied. When the brakes are released, the motor is stopped after a relatively short time interval since a rotating position value of the motor has reached the obtained rotating position value of the motor. Accordingly, unnecessary operational load for release of the brakes may be considerably reduced.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electronic parking brake system comprising:
a brake;
a parking cable to apply braking force to the brake;
a motor configured to rotate in a regular direction or a reverse direction to apply tension to the parking cable;
a motor driving unit to drive the motor;
a current sensor to sense current of the motor;
a hall sensor to sense a rotating position of the motor; and
a control unit to control the motor driving unit,
wherein when the brake is released, the control unit determines whether a rotating position value of the motor sensed through the hall sensor reaches a preset value, and stops the motor through the motor driving unit after a preset time has elapsed since the sensed rotating position value of the motor has reached the preset value.

2. The electronic parking brake system according to claim 1, wherein the preset value is a rotating position value of the motor when tension of the parking cable is approximately zero.

3. The electronic parking brake system according to claim 2, further comprising:
a storage unit to store the preset value,
wherein the preset value is a rotating position value of the motor sensed when a current value of the motor sensed through the current sensor in the operation of the brake reaches a current value corresponding to tension value zero when tension of the parking cable is approximately zero, and the control unit stores the preset value in the storage unit.

4. An electronic parking brake system comprising:
a brake;
a parking cable to apply braking force to the brake;
a motor configured to rotate in a regular direction or a reverse direction to apply tension to the parking cable;
a motor driving unit to drive the motor;
a current sensor to sense current of the motor;
a hall sensor to sense a rotating position of the motor;
a storage unit to store a rotating position of the motor; and
a control unit to control the motor driving unit,
wherein the control unit stores a rotating position value of the motor sensed when a current value of the motor sensed through the current sensor reaches a preset value in the storage unit when the brake is operated, senses a rotating position of the motor when the brake is released, and stops the motor through the motor driving unit after a preset time has elapsed since the sensed rotating position value of the motor has reached the rotating position value of the motor stored in the storage unit.

5. The electronic parking brake system according to claim 4, wherein when the brake is operated, and if a current value of the motor sensed through the current sensor reaches a current value corresponding to tension value zero when tension of the parking cable is approximately zero, the control unit senses a rotating position of the motor through the hall sensor and stores the sensed rotating position value of the motor in the storage unit.

6. The electronic parking brake system according to claim 4, wherein when the brake is operated, and if a rotating position value of the motor sensed through the hall sensor reaches a preset value, the control unit stops the motor.

7. An electronic parking brake system comprising:
a brake;
a parking cable to apply braking force to the brake;
a motor configured to rotate in a regular direction or a reverse direction to apply tension to the parking cable;
a motor driving unit to drive the motor;
a current sensor to sense current of the motor;
a hall sensor to sense a rotating position of the motor; and
a control unit to control the motor driving unit,
wherein when the brake is released, the control unit estimates a point of time of stopping the motor based on a rotating position of the motor when a current value of the motor generated in the operation of the brake reaches a current value corresponding to tension value zero when tension of the parking cable is approximately zero, and stops the motor through the motor driving unit at the estimated point of time of stopping the motor.

8. The electronic parking brake system according to claim 7, wherein the point of time of stopping the motor estimated by the control unit is a point of time when a preset time has elapsed since a rotating position value of the motor sensed through the hall sensor in the release of the brake has reached a rotating position value of the motor when a current value of the motor generated in the operation of the brake reaches a current value corresponding to tension value zero when tension of the parking cable is approximately zero.

9. A control method of an electronic parking brake system comprising:
sensing current of a motor applying tension to a parking cable when a brake is operated;
sensing a rotating position value of the motor when the sensed current of the motor reaches a preset value;
storing the sensed rotating position of the motor;
sensing a rotating position of the motor when the brake is released;
determining whether the sensed rotating position value of the motor reaches the stored rotating position value of the motor; and
stopping the motor according to a determination result.

10. The control method according to claim 9, wherein the stopping the motor includes stopping the motor after a preset time has elapsed since the sensed rotating position value of the motor has reached the stored rotating position value of the motor.

11. The control method according to claim 9, wherein the sensing the rotating position of the motor when the brake is operated includes sensing a rotating position of the motor when the sensed current of the motor reaches a current value corresponding to tension value zero when tension of the parking cable is approximately zero.
